(19) United States
(12) Patent Application Publication
(10) Pub. No.: US 2011/0250012 A1
(43) Pub. Date: Oct. 13, 2011

(54) ROADWAY SEALING AND METHOD FOR ITS PRODUCTION

(75) Inventors: Kai PASCHKOWSKI, Jork (DE); Dirk Urbach, Ahrensburg (DE); Raphael Teysseire, Watt (CH); Martin Linnenbrink, Apensen (DE)

(73) Assignee: Sika Technology AG, Baar (CH)

(21) Appl. No.: 13/117,777

(22) Filed: May 27, 2011

Related U.S. Application Data
(63) Continuation of application No. PCT/EP2009/065948, filed on Nov. 27, 2009.

(30) Foreign Application Priority Data
Nov. 27, 2008 (EP) 08170040.3

(51) Int. Cl. E01C 7/32; B32B 5/16; B32B 9/04; B32B 7/12; B27N 3/12; E01C 3/00

(52) U.S. Cl. 404/27; 264/257; 404/75; 428/411.1; 428/343; 428/323

(57) ABSTRACT

A method is disclosed for manufacturing a roadway structure. To provide a good bond between plastic film and a bitumen-based support layer, an adhesive layer is provided that includes at least one fibrous material layer and one thermoplastic that is solid at room temperature. This method can allow for a rapid and efficient formation of a roadway structure.

### RELATED APPLICATIONS

This application claims priority as a continuation application under 35 U.S.C. §120 to PCT/EP2009/065948, which was filed as an International Application on Nov. 27, 2009 designating the U.S., and which claims priority to European Application No. 08170040.3 filed in Europe on Nov. 27, 2008. The entire contents of these applications are hereby incorporated by reference in their entireties.

### FIELD

The present disclosure relates to the field of sealing of roadways on a supporting structure.

### BACKGROUND INFORMATION

Roadways which are applied to a supporting structure, such as to a concrete supporting structure, are known, especially as bridges. These concrete supporting structures can be sealed by bitumen webs. But due to thermoplastic behavior bitumen webs are susceptible to temperature fluctuations.

Elastic plastic webs on the other hand have an elastic behavior which is constant over a wide temperature range and thus perform their function as a seal even under extreme temperature conditions. In roadbuilding, a bitumen-based base layer can be applied as the uppermost layer. But here, a good adhesive bond between the base layer and the material of the supporting structure, especially the concrete, should be present; this of course also encompasses adhesion of all intermediate layers at the same time. For example, adequate adhesion between the plastic film and bituminous base layer is very difficult to solve based on the materials used.

One approach is to use poured asphalt as an adhesive between the plastic layer and the bituminous base layer. But with these systems, first the poured asphalt must be applied at high temperature and the bituminous base layer can only be applied after cooling; on the one hand, as a result of this additional step, the preparation of the sealing or preparation process of the roadway is prolonged and made more expensive. On the other hand, it has been shown that these roadways deform as a result of the high axle loads of the vehicles using the roadway and within a short time lead to unwanted damage of the roadway covering.

WO 2008/095215 circumvents the foregoing issues by using a concrete roadway. It discloses a concrete roadway on a concrete supporting structure with an interposed plastic film and an adhesive layer between the plastic film and the concrete roadway. For adhesion of the concrete roadway to the adhesive layer, the sprinkling of quartz sand into the adhesive layer before its hardening is proposed.

AT 413 990 B is directed to improving the bond between the plastic film and bituminous base layer and proposes using an adhesive primer based on polyurethane onto which a loose granulate of synthetic resin is sprinkled. However, in sprinkling of the granulate, uniform application is difficult to achieve and when the granulate is sprinkled on concrete supporting structures exposed to the wind it can lead, for example, to large amounts of granulate being blown away; this can lead to unwanted material losses or to uncontrolled losses of adhesion.

JP 2004-068363 discloses the application of an adhesive, such as an ethylene-vinyl acetate copolymer, using a primer, to a plastic film, such as a film with holes. But here, a primer must be applied in an additional step, and in addition, a large amount of polymer is introduced into the bond which can weaken the mechanics of the bond due to the adhesive added over the entire surface.

### SUMMARY

A method is disclosed which produces a roadway structure, and comprises (i) applying a primer to a supporting structure; (ii) applying a plastic film to the supporting structure which was primed; and either: (iii′) applying a plastic primer to the plastic film; and (iv′) applying a fiber material layer which has a thermoplastic that is solid at room temperature adherently applied to one side of the fiber material layer, application of the fiber material layer taking place such that a side of the fiber material layer opposite the one side which has the thermoplastic is brought into contact with the plastic primer; or (iii″) applying a fiber material layer which has a hot-melt adhesive applied on one side, and which has a thermoplastic which is solid at room temperature adherently applied to another side, application of the fiber material layer taking place such that the side of the fiber material layer which has the hot-melt adhesive is brought into contact with the plastic film; or (iii′″) applying a film of a thermoplastic which is solid at room temperature and which has a hot-melt adhesive on a side of the film which faces the plastic film; and (v) applying a bitumen-based base layer.

A system is disclosed which comprises a fiber material layer, and a thermoplastic applied on one side of the fiber material layer, the thermoplastic being solid at room temperature.

A method is disclosed which produces a fiber material layer, the method comprising applying a granulate of thermoplastic which is solid at room temperature to a layer of a fiber material; and heating the thermoplastic with a heat source.

A roadway structure is disclosed which comprises a supporting structure whose surface is coated with a primer, on which a plastic film is attached; a bitumen-based base layer; and an adhesive layer which is located between the plastic film and the base layer, wherein the adhesive layer has a fiber material layer and at least one adhesive which is a thermoplastic which is solid at room temperature.

### BRIEF DESCRIPTION OF THE DRAWINGS

Additional refinements, advantages and features of the present disclosure are described in more detail below with reference to exemplary embodiments illustrated in the drawings. The same elements are provided with the same reference numbers in the various drawings. The direction of flow of the media is indicated with arrows.

Exemplary embodiments are detailed below using the drawings. The same components are provided with the same reference numbers in the different figures. Movements are indicated with arrows. In the drawings:

FIG. 1 shows a cross section through an exemplary supporting structure with applied primer and plastic film (situation during and after step (ii));

FIG. 2 shows a longitudinal cross section through an exemplary production facility for producing a fiber material layer;

FIG. 3 shows a longitudinal cross section through an exemplary production facility for producing a fiber material layer with a hot-melt adhesive;

FIG. 4a shows a cross section through an exemplary fiber material layer;

FIG. 4b shows a cross section through an exemplary fiber material layer with applied hot-melt adhesive;

FIG. 4c shows a cross section through an exemplary thermoplastic film with a fiber material layer with applied hot-melt adhesive;

FIG. 5 shows a cross section through an exemplary supporting structure with applied primer, plastic film, plastic primer and fiber material layer (situation during and after step (iv′));

FIG. 6 shows a cross section through an exemplary supporting structure with applied primer, plastic film, and fiber material layer with a hot-melt adhesive (situation during and after step (iii′″));

FIG. 7 shows a cross section through an exemplary supporting structure with applied primer, plastic film and thermoplastic film with hot melt adhesive (situation during and after step (iii′″));

FIG. 8 shows a cross section through an exemplary roadway structure.

The drawings are schematic, and include only components sufficient for a direct understanding of the exemplary embodiments and variations thereof.

### DETAILED DESCRIPTION

The present disclosure is directed to a roadway structure which can be easily and efficiently produced. By controlled application of adhesive between a plastic film and a bituminous base layer in a manner as disclosed herein, a surprisingly good adhesive bond can be achieved without the mechanics of the bond being unacceptably weakened.

A roadway structure, as disclosed herein, can have favorable long-term behavior even under high axle loads of vehicles. This can make it possible to seal a roadway on a supporting structure, such as on a concrete supporting structure, in a prompt and cost-effective manner.

It has been shown that this roadway structure among others can be produced using a fiber material layer as disclosed herein. Any desired adhesive can be distributed and fixed in a controlled manner in an industrial process on the fiber material layer, and this fiber material layer can be used prefabricated with adhesive at the construction site.

For example, the use of poured asphalt can be avoided. One exemplary advantage here lies in that the fiber material layer, which has the adhesive, or the film, of the thermoplastic which is solid at room temperature after its application can be immediately walked or driven over, and if desired, can be coated immediately with the bituminous base layer, so that compared to known systems, working times can be greatly shortened.

Exemplary embodiments are thus directed to a method for producing a roadway structure which includes: (i) application of a primer to a supporting structure, such as application of a concrete primer to a concrete structure; (ii) application of a plastic film to the supporting structure primed after step (i); and then either (iii′) application of a plastic primer to the plastic film; and (iv′) application of a fiber material layer on which on one side a thermoplastic which is solid at room temperature is adhesively applied, the application of the fiber material layer taking place such that the side of the fiber material layer opposite the side which has the thermoplastic is put into contact with the plastic primer; or (iii″) application of a fiber material layer to which on one side a hot-melt adhesive is applied and on the other side a thermoplastic which is solid a room temperature is adhesively applied, the application of the fiber material layer taking place such that the side of the fiber material layer which has the hot-melt adhesive is brought into contact with the plastic film; or (iii′″) application of a film of a thermoplastic which is solid at room , temperature and which has a hot-melt adhesive on the side of the film facing the plastic film; and (v) application of a bitumen-based base layer.

In a first step (i), a primer is applied to a supporting structure.

This supporting structure can, for example, be a product of underground engineering or overground construction. This can include a bridge, an avalanche protector, a tunnel, an on or off ramp or a parking deck. A bridge is one example of a supporting structure. The supporting structure which is used for a roadway is a structure of a material which can have a bearing function. This material can, for example, be a metal or metal alloy or a concrete, such as a reinforced concrete (e.g., a ferroconcrete).

A concrete bridge is considered an example of such a supporting structure.

On the supporting structure there can be a primer, such as a concrete primer. In this document a “primer” is referred to as a thin layer of a polymer which has been applied to a substrate and which can improve the adhesion between this substrate and another substrate. A primer can have flowable consistency at room temperature and can be applied to the substrate by painting, spreading, rolling, spraying, pouring or brushing. It should be noted that in this connection the term “flowable” refers to not only liquid, but also more highly viscous honey-like to pasty materials whose form is adapted under the influence of the earth's gravity.

In this document a “concrete primer” refers to a thin layer of a polymer which is applied to the concrete and which improves adhesion of concrete to another substrate. For example, concrete primers can be primers based on epoxy resin. They can be two-part epoxy resin primers whose one component (i.e., the first) contains an epoxy resin, such as an epoxy resin based on bisphenol-A-diglycidyl ether and the other component (i.e., the second) contains a hardener, such as a polyamine or a polymercaptan. For example, epoxy resin primers which do not have fillers can be especially preferred. Furthermore, the concrete primers can be thin-liquid, such as those with a viscosity of less than 10,000 mPas, for example, between 10 and 1,000 mPas so that they can penetrate into the concrete surface. Two-part, thin-liquid, epoxy resin primers as are marketed under the serial trade names Sikafloor® or Sikagard® from Sika Deutschland GmbH or Sika Schweiz AG are, if exemplary systems, especially preferred as concrete primers. Sikafloor®—156 first coat and Sikagard®—186 are, the exemplary systems, especially preferred as concrete primers.

For other materials there are adequate primers, for steel a steel primer, as are known to those skilled in the art.

Furthermore, in exemplary embodiments, it can be preferred if inorganic sprinkling agents, such as sand (e.g., quartz sand) are sprinkled into the primer, such as into the concrete primer between step (i) and step (ii). In order to ensure a good bond between the sprinkling agents and primer, especially concrete primers, it can be advantageous if this sprinkling agent is sprinkled before setting of the primer.

In exemplary embodiments, it is preferred if this inorganic sprinkling agent has a maximum grain size of less than 1 mm, especially between 0.1 and 1 mm, preferably, for example, between 0.3 and 0.8 mm.

The amount of these scattering agents should however be dimensioned such that the primer is not blanketed, but that in the structure there are sites where the primer is in direct contact with the plastic film.

It was found that the use of scattering agents can be advantageous for the bond between the plastic film and primer or the supporting structure. Possible explanations which however do not limit the disclosure are that the primer flows at least partially around the grain surface and thus a larger contact surface is created between the plastic film and primer and/or that the inorganic scattering agents greatly strengthen the primer layer locally so that greater forces between the plastic film and supporting structure can be transferred or absorbed and/or purely mechanical anchoring between the plastic film and primer takes place by the scattering agent by the grains which have been incorporated into the matrix of the primer leading to a roughened primer surface and these grains embedding in the surface of the exemplary elastic plastic film. In the case of a plastic film which has been produced on site, such as those produced by an injection process, the plastic film acquires a much larger contact surface since it is applied to a primer surface which has a much larger surface as a result of the roughening caused by the scattering agent.

With reference to the primer layer thickness, those skilled in the art will appreciate that it can also can depend of strongly depend on the surface roughness of the supporting structure and also whether scattering agents are used or not. The average layer thickness of the primer is, for example, between 100 microns and 10 millimeters, and the average layer thickness of the primer layer is, less than 3 mm, preferably in exemplary embodiments between 0.3 and 2 mm.

Then, in step (ii) a plastic film is applied to the supporting structure which is primed after step (i).

In order to be as suitable as possible as plastic film, the plastic film should be as watertight as possible and should not decompose or be mechanically damaged even under the longer influence of water or moisture. Plastic films are, for example, those films as are used for sealing purposes, such as for roofing or for the bridge sealing purpose. In order to be as damaged or altered as little under the influence of temperature by application of the bitumen-based base layer, it can be advantageous if the plastic films are made of material with a softening point of, for example, more than 140° C., preferably between 160° C. and 300° C. The plastic film should advantageously have an at least small amount of elasticity for example to be able to bridge the expansion differences caused by temperatures between the asphalt or supporting structure or stresses caused by cracks in the supporting structure or base layer without the plastic film being damaged or tearing and without the sealing function of the plastic film being adversely affected. Plastic films such as those based on polyurethanes or polyureas or poly(meth)acrylates or epoxy resins are especially preferred. The plastic film can be used as a prefabricated web. In this case the plastic film is, for example, produced by an industrial process in a film mill and is used as the construction site, such as in the form of a plastic film off a roll. It can be advantageous if in this case the plastic film is brought into contact with the primer before its complete curing or hardening.

The plastic film can however be produced on site, for example by a crosslinking reaction of reactive components which are mixed and applied on site. Injected plastic films have proven especially advantageous in exemplary embodiments.

The plastic film advantageously has a layer thickness in, for example, the millimeter range, such as, for example, between 0.5 and 15 mm, preferably between 1 and 4 mm.

Polyurethane films, such as injected films formed of a two-part polyurethane composition are, for example, most preferred as plastic film.

Exemplary embodiments as disclosed herein can ensure the bond between the plastic film and bitumen-based base layer by application of bonding means such as an adhesive layer containing at least one adhesive which is a thermoplastic which is solid at room temperature. At this point, this thermoplastic which is solid at room temperature in use at the construction site is bonded (adhering), and is not in the form of loose granulate.

The term “adhering” in this document describes both “bonded as a result of chemical or physicochemical interaction” and also “bonded as a result of mechanical interaction”. Thus, for example, a thermoplastic which solidifies in the molten state in fiber pores or intermediate fiber spaces and is subsequently anchored with or in the fiber is called adhering.

Features described herein can be achieved by the three exemplary different versions described herein.

In a first exemplary version, in one step (iii′) the plastic primer is applied to the plastic film. Then a fiber material layer is applied in step (iv′). In this connection, on one side a thermoplastic which is solid at room temperature is applied adherently to the fiber material layer. The application of a fiber material layer takes place such that the side of the fiber material layer opposite the side which has the thermoplastic is brought into contact with the plastic primer.

For example, primers of two-part polyurethane compositions or epoxies are used as plastic primers.

The fiber material layer is built up from fibers. The fibers are, for example, of inorganic, organic or synthetic material. Fibers of inorganic material are especially glass fibers and carbon fibers. For example, they are cellulose fibers, cotton fibers or synthetic fibers. Synthetic fibers are mainly preferably, for example, fibers of polyester or of a homopolymer or copolymer of ethylene and/or propylene or of viscose. The fibers can be short fibers or long fibers, spun, woven or unwoven fibers or filaments. Furthermore, the fibers can be directional or stretched fibers. Furthermore, it can be advantageous to use fibers which are different both in geometry and also composition, with one another. Fibers of polyester or polypropylene are, for example, preferred.

To improve the mechanical strengthening of the fiber material layer, it can be advantageous if at least one part of the fibers includes (e.g., consists of) high tension or very high tension fibers, such as of glass, carbon or aramids.

For example, fiber material layers are used which are woven, nubbed or knit. In exemplary systems, felts or nonwovens or knits are preferred and nonwovens are especially preferred.

The fiber material layer can be a looser material of staple fibers, filaments whose coherence is generally dictated by the adhesion which is inherent in the fibers. In this connection the individual fibers can have a preferential direction or can be nondirectional. The fiber material which has been built up from fibers can be mechanically consolidated by needling, meshing or by interlacing by means of sharp water jets and, for example, has a base weight of roughly 300 g/m² and can be transported as mats or in the form of rolls. The fiber material layer can be used in the form of mats or rolls, this can greatly facilitate installation.

Because a fiber material layer is fundamentally porous, good penetration of the materials coming into contact with the fiber material layer is ensured; there are no air or solvent inclusions which could weaken the bond. But it is also ensured that based on the fibers, fixing of the thermoplastics is possible and mechanical strengthening of the bond takes place. Moreover it is enabled by the fiber material layer in that it is rolled and thus can be easily stored or transported. Furthermore it is ensured such that the thermoplastic fixed on it is used in the correct amount, both with reference to its three-dimensional distribution and also with reference to the absolute amount (neither too much or too little).

The fibers of the fiber material layer can also be connected by organic polymers. These polymers help the fibers fix better among one another. Moreover the fiber material layer can contain additives such as for example adhesives, fiber sizings or biocides.

A biocide is for control of pathogenic microorganisms such as for example bacteria, viruses, spores, fungi and molds, or for control of microorganisms which can attack and break down the fibers, the plastic film or the primer. The biocide can be present on or in the fibers. In the former case fibers are sprayed with a biocide or dipped into a biocide. In the latter case the biocide is used in producing or working of fibers and is thus incorporated into the fibers.

By using fiber sizings and/or adhesives a better bond of the fibers with thermoplastic, plastic primer or hot-melt adhesive and in any case bitumen is achieved.

In exemplary embodiments, the thermoplastic which is solid at room temperature can be applied fixed on the fiber material layer. The thermoplastic is on the surface of the fiber material layer.

The thermoplastic can be joined to the fiber material layer (e.g., adhere), to varying degrees of strength. In exemplary embodiments, it is fundamentally only important that there is a bond between the fiber material layer and thermoplastic. This can prevent significant amounts of thermoplastics from being removed by wind or by slight movements as are present in the application of the fiber material layer in step (iv′). The thermoplastic can on the one hand be present only on the surface or can on the other hand moreover penetrate differently into the fiber material layer. Furthermore the thermoplastic can be applied to the fiber material layer over the entire surface or such that the fiber material surface layer is only partially occupied by the thermoplastic.

Thermoplastics which are solid at room temperature are, for example, preferably mainly organic polymers which have a melting point of more than 100° C. especially between 100° C. and 180° C., preferably between 110° C. and 140° C. Any melting points of polymers are defined in this document as softening points measured according to the ring and ball method according to DIN ISO 4625.

For example, polymers are suitable which can be produced from the polymerization of one or more unsaturated monomers. These unsaturated monomers are, for example, those monomers which are chosen from the group including (e.g., consisting of) ethylene, propylene, butylene, butadiene, isoprene, styrene, vinyl ester, especial vinyl acetate, acrylic acid, methacrylic acid, acrylic aid ester, methacrylic acid ester and acrylonitrile.

For example, polyolefins, especially poly-α-olefins, have proven preferable as thermoplastics which are solid at room temperature. Atactic poly-α-olefins (APAO) are, for example, preferred as thermoplastics which are solid at room temperature.

Ethylene vinyl acetate copolymers (EVA), such as those with a vinyl acetate proportion of less than 50%, especially with a vinyl acetate proportion between 10 and 40%, preferably 15 to 30%, are, for example, proven preferable as thermoplastics which are solid at room temperature.

For example, preferably the thermoplastic which is solid at room temperature is applied in the form of thermoplastic spheres which adhere to the surface of the fiber material.

The amount of thermoplastic can, for example, advantageously be such that on the one hand there is enough thermoplastic to achieve a good adhesive bond to the bituminous base layer and on the other hand there is not too much thermoplastic which would prevent rolling of the fiber material.

The thermoplastic is, for example, preferably applied to the fiber material layer in an industrial process. This can take place by melting-on and spraying or doctoring with this melt or preferably by applying thermoplastic granulate to the fiber material layer and subsequent fixing by the influence of heat and melting-on of the thermoplastic.

The thermoplastic granulate preferably has an exemplary diameter of 1 to 10 mm, such as from 3 to 6 mm.

It is, for example, preferable if this fiber material layer is used with a thermoplastic which is solid at room temperature and which adheres to the surface of the fiber material in the form of a roll.

Thus the fiber material travels easily to the construction site and can be unrolled there and cut to the required dimensions. This is a very cost-efficient and time-saving working step.

The application of the fiber material layer in step (iv′) can take place within the open time of the plastic primer. The plastic primer specifically at this instant has a certain inherent strength, but is still at least slightly tacky. As a result this entails an advantage that the fiber material layer is fixed on the base and its slippage is largely prevented. This can be especially advantageous when operations take place in high winds. The application of the fiber material layer in the still tacky plastic primer saves time because it is not necessary to wait until the primer is set. The fiber material layer can be applied preferably by standing on the fiber material layer and moving forward by unrolling the fiber material layer and continuing to walk on the unrolled fiber material layer on the structure. As dictated by the porosity of the fiber material layer can be ensured that good contact with the plastic primer takes place, but it does not completely penetrate the fiber material layer so that the user does not come into contact with the still tacky plastic primer.

In a second exemplary version, after step (ii), in step (iii′) a fiber material layer on which on one side a hot-melt adhesive is applied and on the other side a thermoplastic which is solid at room temperature is adherently applied is applied to the plastic film without primer. The application of the fiber material layer takes place here such that the side of the fiber material layer which has the hot-melt adhesive is brought into contact with the plastic film.

This is an embodiment which can be advantageous compared to the first version in that plastic primer need not be used here and one working step at the construction site can be eliminated. With regard to the fiber material layer, the thermoplastic which is solid at room temperature and its production and preferences, reference is made to, for example, the statements made regarding the first version. The hot-melt adhesive which is used in the second version can be applied to the side of the fiber material layer which has been placed against the thermoplastic.

The hot-melt adhesive can be any known hot-melt adhesive. Rubber-based, polyolefin-based or (meth)acrylate-based hot-melt adhesives can, for example, be especially advantageous.

The hot-melt adhesive can be applied to the surface of the fiber material layer via a slotted nozzle or spray nozzle.

The layer thickness of the hot-melt adhesive is, for example, between 10 and 100 microns, such as between 30 and 50 microns.

In order to prevent unwanted cementing of fiber material layers among one another, especially when they are being rolled, it can be advantageous if the hot-melt adhesive is protected with a separating paper, for example a siliconized paper.

Immediately before applying the fiber material layer to the plastic film in step (iii′), at the construction site the separating paper is removed so that the hot-melt adhesive can be brought into contact with the plastic film. The hot-melt adhesive ensures that the fiber material layer is fixed on the plastic film and its slippage is largely prevented. This can be especially advantageous when it is necessary to work in high winds.

In a third exemplary version, after step (ii) in step (iii′″) a film of a thermoplastic which is solid at room temperature and which is coated on one side with a hot-melt adhesive is applied to the plastic film without primer. Here application takes place such that the side which has the hot-melt adhesive is brought into contact with the plastic film.

This method can be advantageous in that a plastic primer need not be used here, and thus one working step can be eliminated at the construction site.

The film of the thermoplastic which is solid at room temperature is, for example, preferably produced by an extrusion method and a calendering method in which a hot-melt adhesive on one side of the film is, for example, applied to the surface of the thermoplastic film via a slotted nozzle or spray nozzle. The layer thickness of the hot-melt adhesive is, for example, between 10 and 100 microns, such as between 30 and 50 microns. The layer thickness of the thermoplastic film is for, example, between 0.5 mm and 1.5 cm, preferably between 0.5 mm and 5 mm, preferably between 1 mm and 3 mm.

In order to prevent unwanted sticking of the thermoplastic films among one another, especially when they are being rolled, can be advantageous if the hot-melt adhesive is protected with a separating paper, for example a siliconized paper.

With regard to the thermoplastic which is solid at room temperature and the hot-melt adhesive and their preferences, reference is made to the first and second version.

Immediately before application of the fiber material layer to the plastic film in step (iii′″) at the construction site the separating paper can be removed so that the hot-melt adhesive can be brought into contact with the plastic film. The hot-melt adhesive ensures that the fiber material layer is fixed on the plastic film and its slippage is largely prevented. This can be especially advantageous when it is necessary to work in high winds.

Of the three versions described above, the first two versions can in certain circumstances be preferred because the mechanical strengthening can constitute an important advantage. The second version can be preferred, because the advantages of mechanical strengthening, and the elimination of one step of an application of a plastic primer with a primer-rapid working sequence, are realized at the construction site.

Following step (iv′) or (iii″), or (iii′″), in step (v), a bitumen-based base layer can be applied.

This base layer constitutes a roadway which is in direct contact with vehicles. The bituminous-base layer is heated before application to, for example, a temperature of 140° C. to 160° C. and rolled by, for example, means of a roller. The application of the bitumen base layer is known to those one skilled in the art and is therefore not further explained here. In addition to bitumen the base layer can have other possible components known to those skilled in the art. Those skilled in the art know the type and amount of the components of bitumen-based compositions which are best used for preparing the roadways. Here, the base layer can, to a considerable extent, have mineral fillers, such as sand or gravel.

An exemplary difficulty of ensuring a good adhesive bond between the plastic film and base layer can be attributed to this mixing of mineral components and bitumen and as a result the greatly differing hydrophilia or hydrophobia and the associated different wetting properties can be explained.

When the molten bitumen comes into contact with the thermoplastic which is solid at room temperature, it melts on according to its melting point. If it melts on, depending on the type of thermoplastic, it can form a largely homogeneous thermoplastic layer or can also dissolve in the bitumen near the surface and form a thermoplastic-containing boundary phase layer. According to exemplary embodiments, the thermoplastic which is solid at room temperature need not form an individual layer.

The thermoplastic which is solid at room temperature, the optionally present fiber material layer and the hot-melt adhesive or the plastic primer can together form an adhesive layer which ensures a bond between the bitumen base layer and plastic film.

Application can take place immediately after applying the fiber material layer or thermoplastic film since the fiber material layer or thermoplastic film is dry and can be walked or driven on. For example, it is not necessary to wait either for curing, cooling or an additional intermediate step until the bitumen can be applied.

The roadway structure produced in this way has an exemplary advantage that a long-lasting bond among the individual layers is ensured, that its shape is stable over the long term even under high axle loads and is strengthened by using the fiber material layer; this can be advantageous in sagging or lateral shift of the layers to one another. Moreover, dictated by the porosity of the fiber material layer, mechanical anchoring of the plastic primer or of the hot-melt adhesive on the one hand and the bitumen directly or indirectly via linking by way of the thermoplastic which is solid at room temperature is enabled; this is expressed in a further increase of the bond between the layers. Thus, fatigue cracks which could adversely affect the sealing function of the roadway structure appear much more slowly. This method which is described here thus not only saves time in the production of the roadway structure, but also can entail further savings in maintenance since repair or renovation intervals can be greatly prolonged.

In another aspect, a fiber material is disclosed in which on one side a thermoplastic which is solid at room temperature is adherently applied in the form of thermoplastic spheres which adhere to the surface of the fiber material.

For example, the side of the fiber material layer opposite the side which has the thermoplastic has a hot-melt adhesive.

The fiber material layer can be produced according to exemplary methods in which a layer of a fiber material is strewn with a granulate of thermoplastic which is solid at room temperature and is heated hereon by means of a heat source.

For example, in this method, one side of a fiber material layer is coated with a hot-melt adhesive on the condition that the hot-melt adhesive and thermoplastic which is solid at room temperature are applied to different sides of the fiber material.

Here it can be advantageous if a separating paper is brought into contact with the hot-melt adhesive which has been applied to the fiber material.

It is furthermore advantageous if after cooling of the thermoplastic which has been heated by means of a heat source the fiber material layer is rolled into a roll via a winding device.

In another exemplary aspect, a roadway structure is dislcosed having a supporting structure, such as a concrete supporting structure, whose surface is coated with a primer, especially with a concrete primer, on which a plastic film is attached, as well as a bitumen-based base layer and an adhesive layer which is located between the plastic film and base layer, the adhesive layer having a fiber material layer and at least one adhesive. At least one of the adhesives is a thermoplastic which is solid at room temperature.

Thermoplastic which is solid at room temperature and hot-melt adhesive, for example plastic primer, are called adhesives here.

The components which are used for this purpose, such as a supporting structure, primer, plastic film, bituminous base layer and possible strewable agents, plastic primer and hot-melt adhesive have already been explained in detail.

The thermoplastic of the adhesive layer which is solid at room temperature is located, for example, between the fiber material layer and bitumen-based base layer.

The adhesive layer in one version can have one plastic primer which is located between the fiber material layer and plastic film.

The adhesive layer in one exemplary version has a hot-melt adhesive which is located between the fiber material and the plastic film.

The fiber material layer can, for example, be advantageously a fiber nonwoven.

The plastic film is, for example, advantageously a polyurethane film, such as an injected film of two-part polyurethanes.

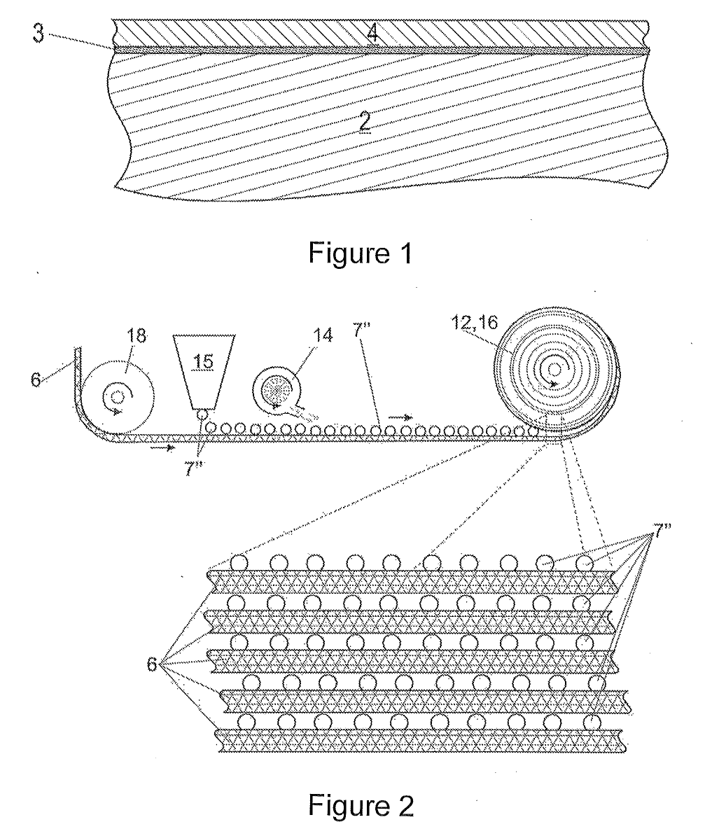

FIG. 1 shows a schematic cross section through an exemplary concrete supporting structure 2 with applied concrete primer 3 and plastic film 4. For this purpose, in a first step (i) a two-part epoxy resin concrete primer 3 is applied to the concrete supporting structure 2. Thereupon, prior to setting, a quartz sand with a grain size 0.4 mm is sprinkled into the primer. Then in step (ii) a plastic film 4 of a two-part polyurethane in a layer thickness of 4 mm is sprayed on the primer. FIG. 1 shows the situation of the roadway structure after step (ii).

FIG. 2 shows a schematic longitudinal cross section through an exemplary production facility for producing a fiber material layer. At the same time, an exemplary method for its production is also shown. Here a fiber material layer 6 is supplied to the coating facility via deflection roller 18. An exemplary thermoplastic 7″ which is solid at room temperature, an EVA with a melting point of 140° C., and a spherical granulate with a diameter from 3 to 4 mm, is spread from a granulate spreader 15 onto the fiber material layer 6 and is heated by means of a heat source 14 so that the thermoplastic 7″, melts easily on the surface and is able to wet and flow onto the fibers in contact with it. Then the thermoplastic 7″ during passage through a cooling zone which is located downstream following the heat source 14, cools so that the thermoplastic is joined to the fiber material layer. Then the fiber material layer 6 with the thermoplastic spheres adhering on the surface of the fiber material is wound into a roll 12 by means of a winding device 16. FIG. 2 shows an enlarged schematic extract of an exemplary roll of a wound fiber material layer 6 with adhering thermoplastic 7″.

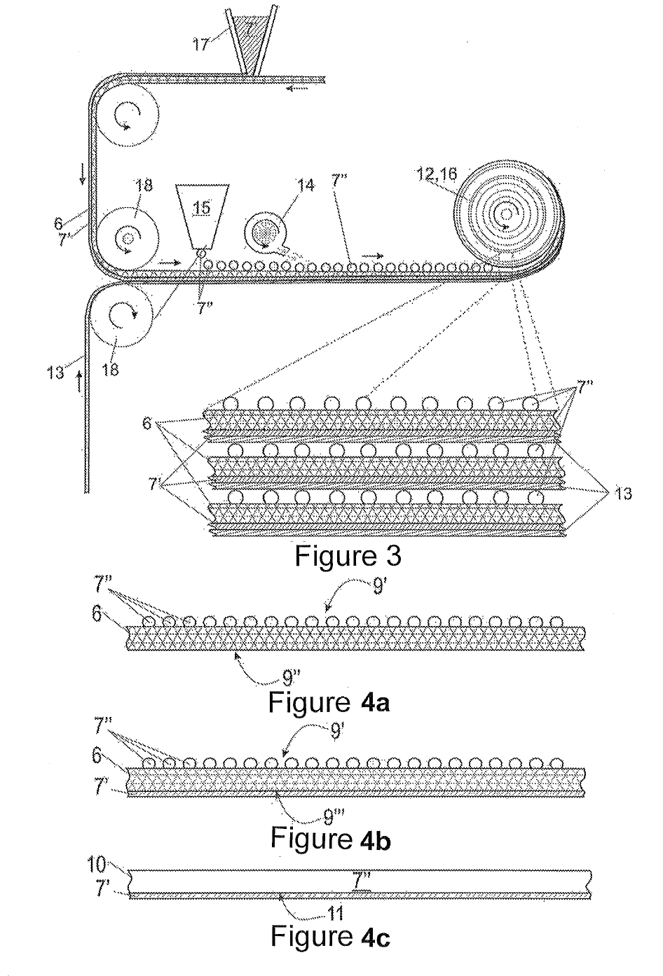

FIG. 3 shows a schematic longitudinal section through an exemplary production facility for producing a fiber material layer with hot-melt adhesive. At the same time, an exemplary method for its production is shown. In addition to the details which have already been described in FIG. 2, FIG. 1 shows a coating of the back of the fiber material layer 6. For this purpose a hot-melt adhesive 7′ from a hot-melt adhesive application device 17 is applied molten to the fiber material layer over the entire surface in a layer thickness of 50 microns. After cooling and turning back the fiber material layer by deflection rolls 18, the hot-melt adhesive 7′ is brought into contact by supplying a siliconized separating paper 13 and covered and rolled together.

Thus, there is a fiber material layer 6 in which the hot-melt adhesive 7′ and the thermoplastic 7″, which is solid at room temperature, are applied on different sides of the fiber material.

In the enlarged extract of roll 12 shown below in FIG. 3, individual layers of separating paper 13, hot-melt adhesive 7′, fiber material layer 6 and thermoplastic spheres 7″ which adhere to the surface of the fiber material are apparent.

FIG. 4a shows a schematic cross section through an exemplary fiber material layer 6 on which on one side the thermoplastic 7″, which is solid at room temperature in the form of thermoplastic spheres which adhere to the surface of the fiber material, is applied adherently. This fiber material layer was produced, for example, by means of a production installation using a method as was described in FIG. 2.

FIG. 4b shows a schematic cross section through an exemplary fiber material layer 6 on which on one side the thermoplastic, which is solid at room temperature in the form of thermoplastic spheres 7″ which adhere to the surface of the fiber material, is applied adherently and the side 9″ of the fiber material layer opposite the side 9′ which has the thermoplastic 7″ has a hot-melt adhesive 7′. This fiber material layer was produced, for example, by means of a production installation using a method as was described in FIG. 3.

FIG. 4c shows a schematic cross section through an exemplary film (10) of a thermoplastic 7″ which is solid at room temperature and which is coated on one side with a hot-melt adhesive 7′.

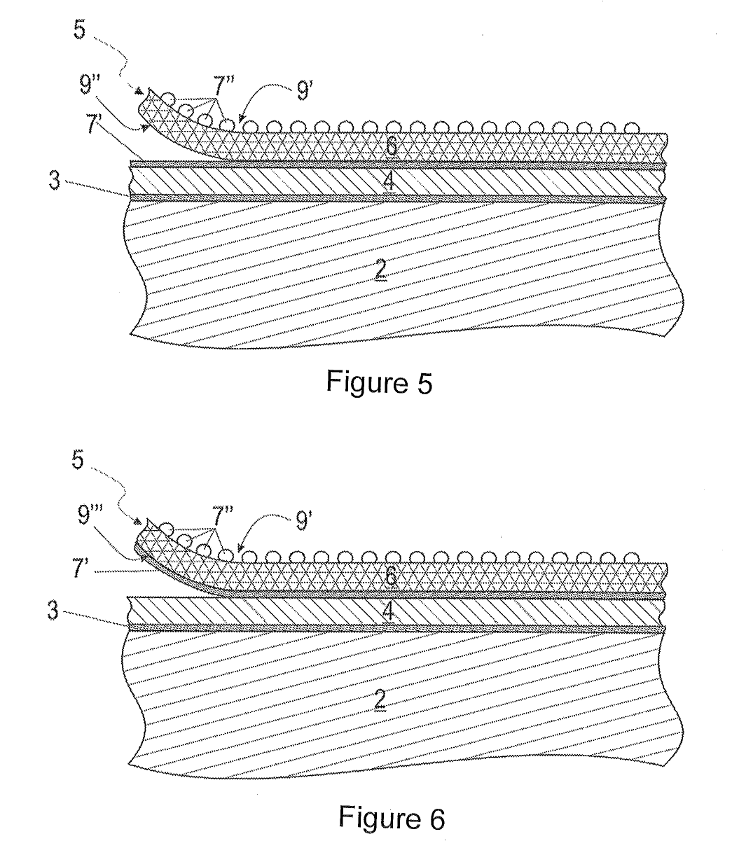

FIG. 5 shows a schematic through an exemplary supporting structure 2 with applied primer 3, plastic film 4, plastic primer 7′ and fiber material layer 6 with thermoplastic 7″.

As was described in FIG. 1, in step (iii′) a plastic primer 7′ was applied to the intermediate step of the roadway structure. The plastic primer is, for example, a primer formed from a two-part polyurethane composition. Then a fiber material layer 6 with solid thermoplastic 7″, as was described in FIG. 4a, is or was placed into the still incompletely cured plastic primer 7′ in step (iv′). This takes place such that the side (9″) of the fiber material layer (6) opposite the side (9′) which has the thermoplastic (7″) is brought into contact with the plastic primer (7′).

FIG. 6 shows a schematic cross section through an exemplary supporting structure 2 with applied primer 3, plastic film 4, hot-melt adhesive 7′, fiber material layer 6 and thermoplastic film 7″.

At the intermediate stage of roadway building, as was described in FIG. 1, a fiber material layer 6 with a hot-melt adhesive 7′ and with solid thermoplastic 7″ as was described in FIG. 4b is or was applied to the plastic film 4. This takes place such that the side 9′″ of the fiber material layer 6 which has the hot-melt adhesive is brought into contact with the plastic film 4.

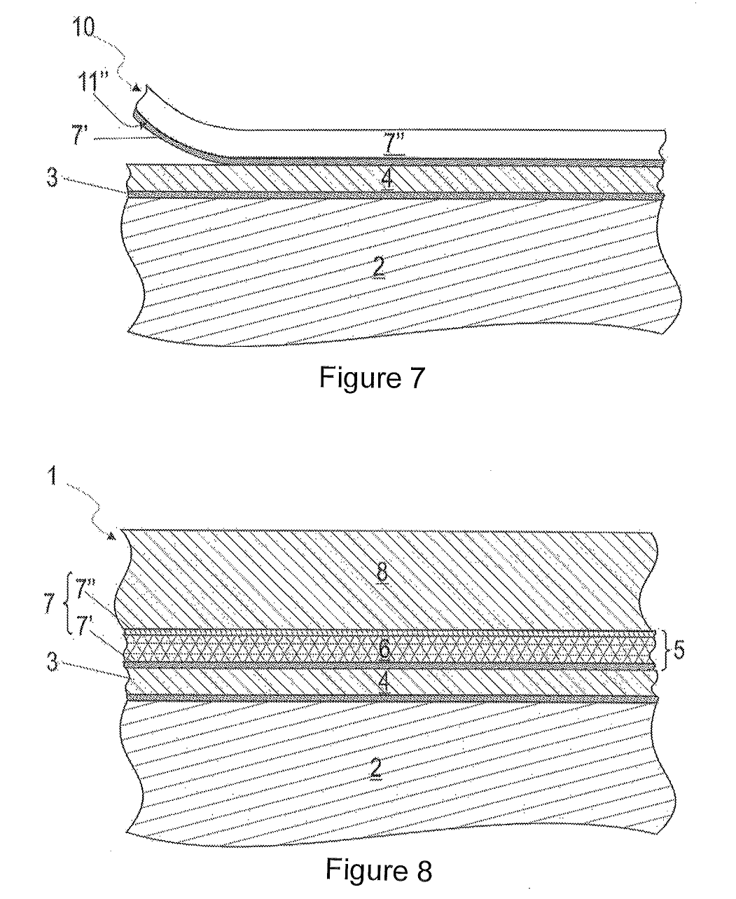

FIG. 7 shows a schematic cross section through an exemplary supporting structure 2 with applied primer 3, plastic film 4, hot-melt adhesive 7′, and thermoplastic film 10.

In step (iii′″) in FIG. 7, a film 10 of a thermoplastic 7′, which is solid a room temperature and which has a hot-melt adhesive 7′ on the side 11 of the film 10 facing the plastic film 5, is or has been applied to the plastic film 4 at the intermediate stage of roadway construction.

FIG. 8 shows a schematic cross section through an roadway structure.

At the intermediate stage of roadway construction, as was described in FIG. 5 or 6, a bitumen-based base layer 8 was applied in step (v). The thermoplastic spheres 7″ were heated by contact with the molten bitumen and are melted. For the sake of simplicity in the representation shown here the thermoplastic 7″ is shown as a blanket layer. The fiber material layer 6 and adhesive 7 (e.g., thermoplastic 7″ and plastic primer 7′ or hot-melt adhesive 7′), together form an adhesive layer 5 which joins the bitumen-based base layer 8 and the plastic film 4 to one another.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMBER LIST

1 roadway structure

2 supporting structure, concrete supporting structure

3 primer, concrete primer

4 plastic film

5 adhesive layer

6 fiber material layer

7 adhesive

7′ adhesive, plastic primer, hot-melt adhesive

7″ adhesive, thermoplastic

8 bitumen-based base layer

9′ side of the fiber material layer 6 which has thermoplastic 7″

9″ side of the fiber material layer 6 opposite the side 9′ which has the thermoplastic 7″

9′″ side of the fiber material layer 6 which has the hot-melt adhesive

10 film of a thermoplastic 7″ which is solid at room temperature

11 side of the film 10 facing the plastic film 5

12 roll

13 separating paper

14 heat source

15 granulate spreader

16 winding device

17 hot-melt adhesive application device

18 deflection roll

What is claimed is:

1. Method for producing a roadway structure, comprising:
(i) applying a primer to a supporting structure;
(ii) applying a plastic film to the supporting structure which was primed; and either:
(iii′) applying a plastic primer to the plastic film; and
(iv′) applying a fiber material layer which has a thermoplastic that is solid at room temperature adherently applied to one side of the fiber material layer, application of the fiber material layer taking place such that a side of the fiber material layer opposite the one side which has the thermoplastic is brought into contact with the plastic primer;
or
(iii″) applying a fiber material layer which has a hot-melt adhesive applied on one side, and which has a thermoplastic which is solid at room temperature adherently applied to another side, application of the fiber material layer taking place such that the side of the fiber material layer which has the hot-melt adhesive is brought into contact with the plastic film;
or
(iii″′) applying a film of a thermoplastic which is solid at room temperature and which has a hot-melt adhesive on a side of the film which faces the plastic film;
and
(v) applying a bitumen-based base layer.

2. Method as claimed in claim 1, wherein the plastic film is a two-part polyurethane film.

3. Method as claimed in claim 1, comprising:
applying the thermoplastic of (iv′) or (iii″), which is solid at room temperature, as thermoplastic spheres which adhere to a surface of the fiber material layer.

4. A system, comprising:
a fiber material layer; and
a thermoplastic applied on one side of the fiber material layer, the thermoplastic being solid at room temperature.

5. The fiber material layer as claimed in claim 4, wherein a side of the fiber material layer opposite the side which has the thermoplastic comprises:
a hot-melt adhesive.

6. The fiber material layer as claimed in claim 5, configured as a roll.

7. Method for producing a fiber material layer, comprising:
applying a granulate of thermoplastic which is solid at room temperature to a layer of a fiber material; and
heating the thermoplastic with a heat source.

8. Method as claimed in claim 7, comprising:
coating one side of a fiber material layer with a hot-melt adhesive on a condition that the hot-melt adhesive and the thermoplastic which is solid at room temperature are applied to different sides of the fiber material layer.

9. Method as claimed in claim 8, comprising:
bringing a separating paper into contact with the hot-melt adhesive which has been applied to the fiber material layer.

10. Method as claimed in claim 9, comprising:
rolling the fiber material layer, after cooling of the thermoplastic which has been heated by the heat source, into a roll via a winding device.

11. A roadway structure comprising:
a supporting structure whose surface is coated with a primer, on which a plastic film is attached;
a bitumen-based base layer; and
an adhesive layer which is located between the plastic film and the base layer, wherein the adhesive layer has a fiber material layer and at least one adhesive which is a thermoplastic which is solid at room temperature.

12. The roadway structure as claimed in claim 11, wherein the thermoplastic of the adhesive layer which is solid at room temperature is located between the fiber material layer and the bitumen-based base layer.

13. The roadway structure as claimed in claim 12, wherein the adhesive layer comprises:
a plastic primer which is located between the fiber material layer and the plastic film.

14. The roadway structure as claimed in claim 12, wherein the adhesive layer comprises:
a hot-melt adhesive which is located between the fiber material layer and the plastic film.

15. The roadway structure as claimed in claim 11, wherein the fiber material layer is a fiber nonwoven.

16. The roadway structure as claimed in claim 11, wherein the plastic film is a two-part polyurethane film.

17. Method as claimed in claim 1, wherein the supporting structure is a concrete structure, and the plastic film is an injected film of two-part polyurethane composition.

18. The system of claim 4, wherein the thermoplastic comprises:
thermoplastic spheres which adhere to a surface of the fiber material layer.

19. The roadway structure as claimed in claim 11, wherein the plastic film is an injected film of two-part polyurethane composition.
